(19) United States
(12) Patent Application Publication
(10) Pub. No.: US 2025/0355596 A1
(43) Pub. Date: Nov. 20, 2025

(54) MEMORY SUB-SYSTEM FOR MERGING WRITE COMMAND DATA WITH SEQUENTIAL WRITE STREAM DATA

(71) Applicant: MICRON TECHNOLOGY, INC., Boise, ID (US)

(72) Inventors: Shi Jin, Shanghai (CN); Zhuo Zhang, Shanghai (CN)

(21) Appl. No.: 19/200,437

(22) Filed: May 6, 2025

Related U.S. Application Data
(60) Provisional application No. 63/647,683, filed on May 15, 2024.

(51) Int. Cl. G06F 3/06

(52) U.S. Cl. CPC G06F 3/0659; G06F 3/0613; G06F 3/0656; G06F 3/0679

(57) ABSTRACT

Various aspects of the present disclosure relate to a memory sub-system for merging sequential write stream data. A processor associated with the memory sub-system may receive a write command that indicates to write data to a memory device, where a size of the data is smaller than a translation unit size. The processor may determine that the write command is associated with a sequential write stream. The processor may generate a read command that indicates to read other data associated with the sequential write stream from the memory device. The processor may execute a read operation associated with the read command to read the other data from the memory device. The processor may merge the data and the other data to form merged data. The processor may execute a program operation to write the merged data to the memory device.

### RELATED APPLICATIONS

This application claims the benefit of U.S. Provisional Patent Application No. 63/647,683, filed May 15, 2024, the entire contents of which are hereby incorporated by reference herein.

### TECHNICAL FIELD

Aspects of the disclosure relate generally to memory sub-systems, and more specifically, to a memory sub-system for merging write command data with sequential write stream data.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various aspects of the disclosure.

FIG. 1 illustrates an example computing system that includes a memory sub-system, in accordance with some aspects of the present disclosure.

FIG. 2 is a flow diagram of an example method of merging write command data with sequential write stream data, in accordance with some aspects of the present disclosure.

FIG. 3 is a block diagram of a memory sub-system controller for merging write command data with sequential write stream data using a logical-to-physical mapping table, in accordance with some aspects of the present disclosure.

FIG. 4 is a sequence diagram illustrating an example method of using a read look-ahead for merging write command data with sequential write stream data, in accordance with some aspects of the present disclosure.

FIG. 5 is a flow diagram of an example method of merging write command data with sequential write stream data based on translation unit addresses, in accordance with some aspects of the present disclosure.

FIG. 6 is a block diagram of an example computer system in which some aspects of the present disclosure may operate.

### DETAILED DESCRIPTION

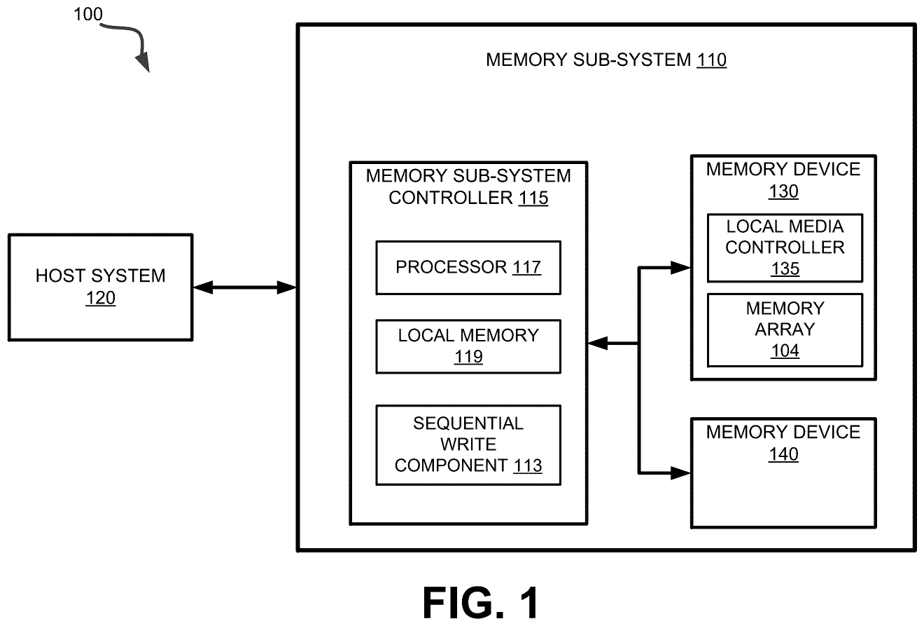

Aspects of the present disclosure are directed to a memory sub-system for merging write command data with sequential write stream data. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1. A non-volatile memory device is a package of one or more dies. Each die can include one or more planes. For some types of non-volatile memory devices (e.g., NAND devices), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can include multiple memory cells arranged in a two-dimensional or a three-dimensional grid. Memory cells are formed onto a silicon wafer in a rectangular array; the memory cells may be joined by conductive lines referred to as wordlines and bitlines. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. For ease of description, these circuits can be generally referred to as independent plane driver circuits. Depending on the storage architecture employed, data can be stored across the memory planes (i.e., in stripes). Accordingly, one request to read a segment of data (e.g., corresponding to one or more data addresses), can result in read operations performed on two or more of the memory planes of the memory device.

One example of a memory sub-system is a solid-state drive (SSD) that includes one or more non-volatile memory devices and a memory sub-system controller to manage the non-volatile memory devices. Certain memory sub-systems use a Flash Translation Layer (FTL) to translate logical addresses of memory access requests, often referred to as logical block addresses (LBAs), to corresponding physical memory addresses, which can be stored in one or more FTL mapping tables. In some instances, the FTL mapping table can be referred to as a logical-to-physical (L2P) mapping table storing L2P mapping information, at least a portion of which may be stored in volatile memory (e.g., Dynamic Random Access Memory (DRAM)) in the memory sub-system so that it can be accessed with minimal latency. During operation, the memory sub-system can receive one or more input/output (I/O) chunks of data (e.g., from a host system) to be stored. Each I/O chunk can be represented by a corresponding LBA and can have a fixed size (e.g., 4 kilobytes) that is set, for example, by the host system. The received data is then written to the non-volatile memory devices at corresponding physical memory addresses at a granularity referred to as a translation unit (TU). The translation unit is the base granularity of data managed by the memory sub-system and can include a predefined number of logical units (e.g., logical pages, logical blocks, etc.). Certain memory devices implement a translation unit size that is equal to the I/O chunk size (e.g., 4 kilobytes). When the translation unit is written to the physical memory address, the memory sub-system controller can create a corresponding entry in the L2P mapping table indicating the correlation between the LBA and the physical memory address. Thus, the L2P mapping table can include an entry for every translation unit written to the non-volatile memory device. As the size of the non-volatile memory device increases (e.g., into the tens of terabytes), the size of the volatile memory needed to store the L2P mapping information quickly surpasses practical limitations including cost, physical size, power utilization, etc.

One approach that can reduce the amount of L2P mapping information, and thus the size of the volatile memory, is to increase the translation unit size. For example, if the host data were written to the non-volatile memory device in larger chunks (e.g., 8 kilobytes or 16 kilobytes) the number of entries in the L2P mapping table could be proportionally reduced. Utilizing a larger translation unit size, however, can lead to increased write amplification when the I/O chunk size is small (e.g., smaller than the translation unit size). For example, if an I/O chunk of 4 kilobytes of host data is received, but the translation unit size being utilized is 16 kilobytes, the memory sub-system controller will read 16 kilobytes of data from the non-volatile memory device, modify 4 kilobytes of the read data, and write the full 16 kilobytes back to the non-volatile memory device. In such an example, an extra 12 kilobytes of identical data is read from and then written back to the non-volatile memory device in order to write the 4 kilobytes of new host data to the non-volatile memory device. This can be referred to as a write amplification factor of four (4). The additional write and read operations can increase latency by reducing input/output operations per second (IOPS) within the memory sub-system. Further, the additional write operations can cause the non-volatile memory device to wear out faster and experience disturb errors, which may reduce the lifetime and reliability of the memory device.

Aspects of the present disclosure address the above and other deficiencies by implementing a memory sub-system for merging write command data with sequential write stream data. The memory sub-system includes a memory sub-system controller that receives a write command indicating to write data to a memory device associated with the memory sub-system, where the size of the data included in the write command is smaller than the translation unit size. Using the example above, the translation unit size may be 16 kilobytes while the write command may indicate for the memory sub-system controller to write data having a size of 4 kilobytes. The memory sub-system controller may determine that the write command is associated with a sequential write stream. In some aspects, a sequential write stream may refer to data that is stored in a continuous, ordered sequence (for example, with increasing address locations and without significant interruptions or random accesses). This differs from random access writing, where data is written to non-consecutive locations in the memory. The memory sub-system controller may generate a read command that indicates to read other data associated with the sequential write stream and may execute a read operation to read the other data from the memory device. In some aspects, the memory sub-system controller may perform a read look-ahead (RLA) operation to identify the other data associated with the sequential write stream. Performing the RLA operation may include pre-fetching data blocks that the memory sub-system controller predicts will be needed soon based on the current read operations (for example, based on previous write operations being directed to contiguous logical block addresses). This may include the memory sub-system controller identifying the next set of data blocks that are likely to be requested and reading them from the memory device into a cache memory (or other location) where they can be accessed by the memory sub-system controller more quickly. The memory sub-system controller can merge the write command data (the data included in the write command) and the other data (the data included in the sequential write stream) to form merged data, where a size of the merged data is equal to the translation unit size. The memory sub-system controller can then execute a program operation to write the merged data to the memory device.

Some advantages of the present disclosure include improving memory sub-system performance. Some advantages of the present disclosure may include reducing write amplification on the memory device, for example, by merging write command data with other data included in a sequential write stream. Some advantages of the present disclosure may include reducing latency in the memory sub-system, for example, by enabling the memory sub-system controller to read the sequential write stream data ahead of time and to store the sequential write stream data in a buffer or cache where it can be accessed more quickly. Some advantages of the present disclosure may include increasing a lifespan and reliability of the memory device, for example, by reducing the number of write operations performed over the life of the memory device. These example advantages, among others, are described in more detail herein.

FIG. 1 illustrates an example computing system 100 that includes a memory sub-system 110, in accordance with some aspects of the present disclosure. The memory sub-system 110 can include media, such as one or more volatile memory devices (e.g., memory device 140), one or more non-volatile memory devices (e.g., one or more memory device(s) 130), or a combination of such.

The memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some aspects, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., the one or more memory device(s) 130) when the memory sub-system 110 is coupled with the host system 120 by the physical host interface (e.g., PCIe or CXL interface). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be random access memory (RAM), such as dynamic random access memory (DRAM) and synchronous dynamic random access memory (SDRAM).

Some examples of non-volatile memory devices (e.g., memory device(s) 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some aspects, each of the memory devices 130 can include one or more arrays of memory cells such as SLCs, MLCs, TLCs, QLCs, or any combination of such. In some aspects, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 115 (or controller 115 for simplicity) can communicate with the memory device(s) 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some aspects, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in some other aspects, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 115 can further include host interface circuitry to communicate with the host system 120 via the physical host interface. The host interface circuitry can convert the commands received from the host system into command instructions to access the memory device(s) 130 as well as convert responses associated with the memory device(s) 130 into information for the host system 120.

The memory sub-system 110 can also include additional circuitry or components that are not illustrated. In some aspects, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some aspects, the memory device(s) 130 include local media controllers 135 that operate in conjunction with memory sub-system controller 115 to execute operations on one or more memory cells of the memory device(s) 130. An external controller (e.g., memory sub-system controller 115) can externally manage the memory device 130 (e.g., perform media management operations on the memory device(s) 130). In some aspects, a memory device 130 is a managed memory device, which is a raw memory device (e.g., memory array 104) having control logic (e.g., local controller 135) for media management within the same memory device package. An example of a managed memory device is a managed NAND (MNAND) device. Memory device(s) 130, for example, can each represent a single die having some control logic (e.g., local media controller 135) embodied thereon. In some aspects, one or more components of memory sub-system 110 can be omitted.

In some aspects, the memory sub-system 110 includes a sequential write component 113 that can be used to merge write command data with sequential write stream data. For example, the sequential write component 113 may determine that a write command (e.g., received from host system 120) is associated with a sequential write stream and may generate a read command that indicates for the memory sub-system controller 115 to read other data associated with the sequential write stream. In some aspects, the sequential write component 113 may use an RLA operation to identify the other data associated with the sequential write stream. For example, the sequential write component 113 may pre-fetch data blocks that the sequential write component 113 predicts will be needed soon based on the current read operations (for example, based on previous write operations being directed to contiguous logical block addresses). The sequential write component 113 may merge the write command data (the data included in the write command) and the other data (the data included in the sequential write stream) to form merged data, where a size of the merged data is equal to the translation unit size. As described herein, this may reduce a latency in the memory sub-system 110, among other benefits.

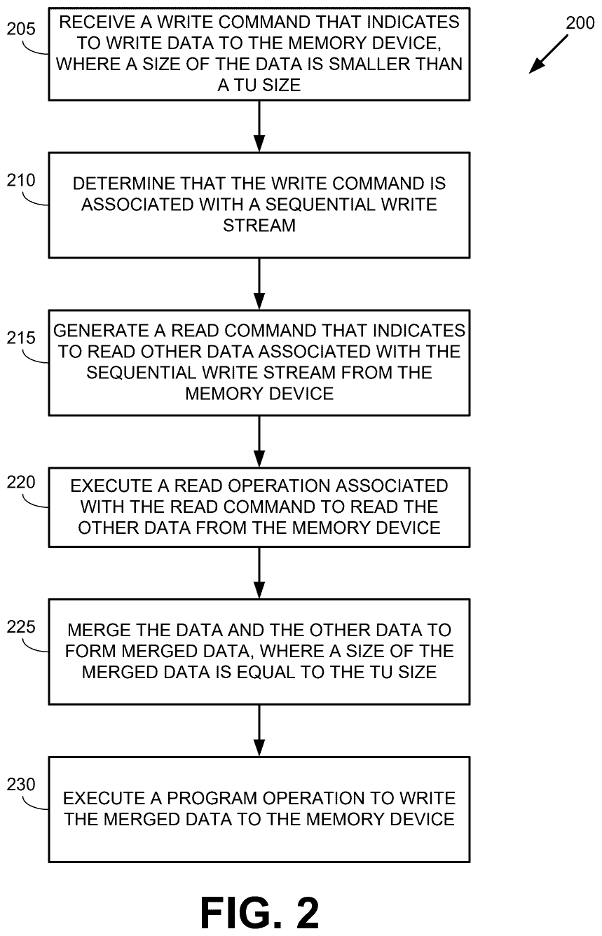

FIG. 2 is a flow diagram of an example method of merging write command data with sequential write stream data, in accordance with some aspects of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some aspects, the method 200 is performed by the sequential write component 113 of FIG. 1. Although shown in a particular sequence or order, unless otherwise specified, the order of the processes can be modified. Thus, the illustrated aspects should be understood only as examples, and the illustrated processes can be performed in a different order, and some processes can be performed in parallel. Additionally, one or more processes can be omitted in various aspects. Thus, not all processes are required in every aspect. Other process flows are possible.

At operation 205, the processing logic (e.g., the sequential write component 113) receives a write command that indicates to write data to a memory (e.g., the memory device 130). The write command may be received by the processing logic from a requestor, such as the host system 120. The size of the data included in the write command may be smaller than a translation unit size. For example, the translation unit size used by the memory sub-system controller 115 may be 16 kilobytes, while the size of the data included in the write command may be 4 kilobytes, 8 kilobytes, or 12 kilobytes, among other examples.

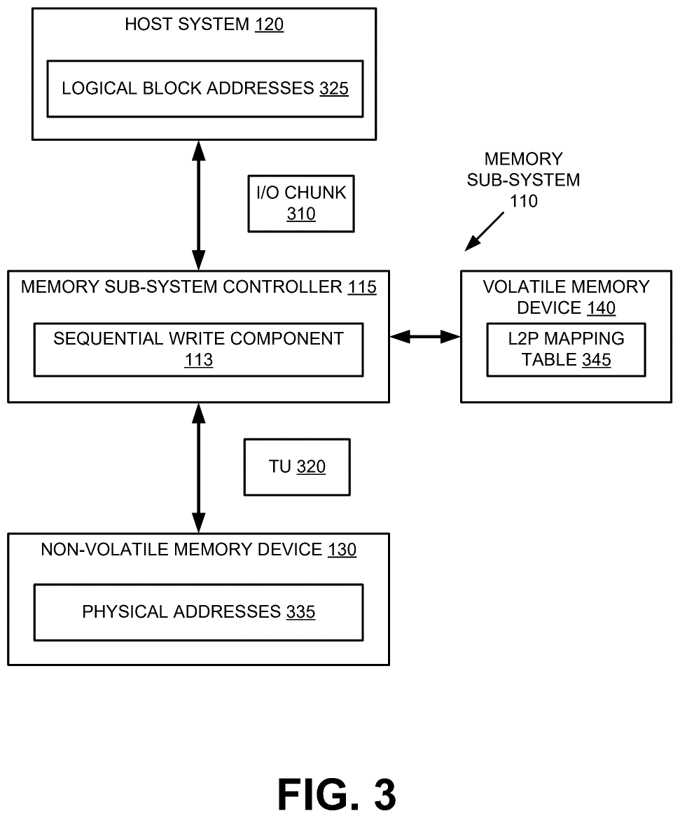

In some aspects, as shown in FIG. 3, the data may be an I/O chunk 310 having a fixed size and the write command may indicate one or more logical block addresses 325 identifying the I/O chunk 310. For example, the host system 120 may transmit a write command that indicates for the memory sub-system controller 115 (e.g., the sequential write component 113) to write a 4 kilobyte I/O chunk 310 associated with a logical block address 325 that corresponds to a physical address in the non-volatile memory device 130.

At operation 210, the processing logic determines that the write command is associated with a sequential write stream. As described herein, a sequential write stream refers to data that is stored in a continuous, ordered sequence (for example, with increasing address locations and without significant interruptions or random accesses). This differs from random access writing, where data is written to non-consecutive locations in the memory device. In some aspects, the processing device can determine that the data is part of the sequential write stream by monitoring the access patterns and addresses of the write commands. If the processing logic determines that the data is to be written in a consecutive order, with increasing memory addresses or block numbers, the processing logic can determine that the write command is part of a sequential stream.

In one example, the processing logic may detect that four previous write commands were directed to LBA 31, LBA 32, LBA 33, and LBA 34, respectively, where each LBA includes 4 kilobytes of data. Therefore, the processing logic may determine that the four previous write commands are associated with a sequential write stream. In this example, LBA 31, LBA 32, LBA 33, and LBA 34 (associated with the four previous write commands) may be associated with a first translation unit, and LBA 35 (associated with the current write command) may be associated with a second translation unit.

In some aspects, the processing logic may determine that write commands are associated with a sequential write stream based on monitoring access patterns. In the example described above, the processing logic may use pattern recognition to analyze the sequence of memory addresses being accessed. If the addresses accessed are contiguous or follow a predictable pattern (e.g., increasing or decreasing in a linear manner), the processing logic may determine that the write operations are sequential writes. In some other examples, the processing logic may use stride detection to identify regular intervals between memory accesses. If the intervals between consecutive memory accesses are consistent, the processing logic may determine that the memory accesses are associated with a sequential access pattern. In some other aspects, the processing logic may use temporal locality analysis to determine a sequential write stream. Temporal locality refers to the tendency of a program to access the same memory locations repeatedly over a short period. By monitoring temporal locality, the processing logic can identify when the same memory locations are being written to in rapid succession, thereby indicating sequential writes. In some other examples, the processing logic may receive information that hints that the upcoming accesses are likely to be sequential. These hints could be in the form of pre-fetching instructions or directives embedded in the code or issued by the host device.

At operation 215, the processing logic generates a read command that indicates to read other data associated with the sequential write stream from the memory device. For example, the processing logic may generate a read command that indicates to read data from one or more subsequent logical block addresses in the sequential write stream. Using the example above, based on detecting that the four previous write commands were directed to LBA 31, LBA 32, LBA 33, and LBA 34, respectively, and based on detecting that the current write command indicates to write the data to LBA 35, the processing logic may determine to read data from one or more subsequent logical block addresses in the sequential write stream. For example, the processing logic may read data from LBA 36, LBA 37, and LBA 38. In some aspects, the processing logic may read the data from the one or more subsequent logical block addresses based on the translation unit size. For example, the processing logic may determine to read data from LBA 36, LBA 37, and LBA 38 since each of LBA 35, LBA 36, LBA 37, and LBA 38 include 4 kilobytes of data and, therefore, form an amount of data that is equal to the translation unit size (16 kilobytes). The processing logic may store the data from LBA 36, LBA 37, and LBA 38 in a buffer, such as a pre-fetch buffer (described below). In some aspects, the processing logic may generate (e.g., build) the internal read command based on a logical block address (LBA) of the write command, a number of logical block addresses (NLB) in the write command, and/or a string identifier (ID).

In some aspects, the processing logic may use an RLA operation to determine the one or more subsequent logical block addresses in the sequential write stream. RLA is a technique that may be employed by the memory sub-system to optimize the efficiency of data retrieval operations. In traditional memory access schemes, when a processor (such as the memory sub-system controller 115) requests data from memory (such as the memory device 130), there is a latency involved in fetching the requested data due to the time it takes for the memory sub-system to locate and retrieve the data. During this latency period, the processor typically remains idle, which can lead to inefficiencies and latency. RLA addresses this issue by enabling the processing logic to proactively fetch additional data from the memory device based on the assumption that the memory sub-system 110 will likely access this additional data in the near future due to the sequential access pattern. By pre-fetching this data into a cache or buffer, the memory sub-system can reduce the impact of memory access latency on the performance of the processing logic, thus improving system speed and efficiency.

In some aspects, the processing logic may store the pre-fetched data in a pre-fetch buffer. The pre-fetch buffer may help reduce memory access latency by providing quick access to the pre-fetched data. Once data is pre-fetched into the pre-fetch buffer, the data may be transferred to a cache or made available for direct access by the processor. In some aspects, the processing logic may access one or more pre-fetching policies that indicate when and how the pre-fetching should be triggered. The pre-fetching policies may include parameters such as a pre-fetch distance (e.g., how far ahead to pre-fetch), a pre-fetch depth (e.g., how many cache lines or memory blocks to pre-fetch), and one or more pre-fetch trigger conditions (e.g., based on observed access patterns or explicit hints from the processor).

At operation 220, the processing logic executes a read operation associated with the read command to read the other data from the memory device. For example, the processing logic may execute the read command to read the data from LBA 36, LBA 37, and LBA 38, as described above.

At operation 225, the processing logic merges the data and the other data to form merged data. For example, the processing logic may merge the write data with the other data included in LBA 36, LBA 37 and LBA 38 to form the merged data. For example, the processing logic may merge the 4 kilobytes of write data (received from the host device) with the 12 kilobytes of data stored in LBA 36, LBA 37, and LBA 38. Therefore, the size of the merged data may be equal to the translation unit size (e.g., 16 kilobytes).

At operation 230, the processing logic executes a program operation to write the merged data to the memory device. For example, the processing logic may execute a program operation to write the 16 kilobytes of merged data included in LBA 35, LBA 36, LBA 37, and LBA 38 to the corresponding physical addresses in the memory device. Since the other data stored in LBA 36, LBA 37, and LBA 38 are already in the pre-fetch buffer or the cache, latency associated with writing the data may be reduced.

In some aspects, as shown in FIG. 3, the memory sub-system controller 115 (e.g., using the sequential write component 113) may write the merged data to the non-volatile memory device 130 as TU 320. For example, the memory sub-system controller 115 may write the TU 320 to one or more physical addresses 335 corresponding to LBA 35, LBA 36, LBA 37, and LBA 38. Additionally, the memory sub-system controller 115 may maintain an L2P mapping table 345. At least a portion of the L2P mapping table 345 may be stored in the volatile memory device 140. The L2P mapping table 345 may indicate relationships between the logical block addresses 325 (communicated between the memory sub-system controller 115 and the host system 120) and the physical addresses 335 (communicated between the memory sub-system controller 115 and the non-volatile memory device 130). Therefore, when executing the program operation to write the merged data to the non-volatile memory device 130, the memory sub-system controller 115 may access the L2P mapping table 345 to determine the physical addresses 335 corresponding to LBA 35 (indicated by the host system 120 for writing the data) and LBA 36, LBA 37, and LBA 38 (associated with the sequential write stream).

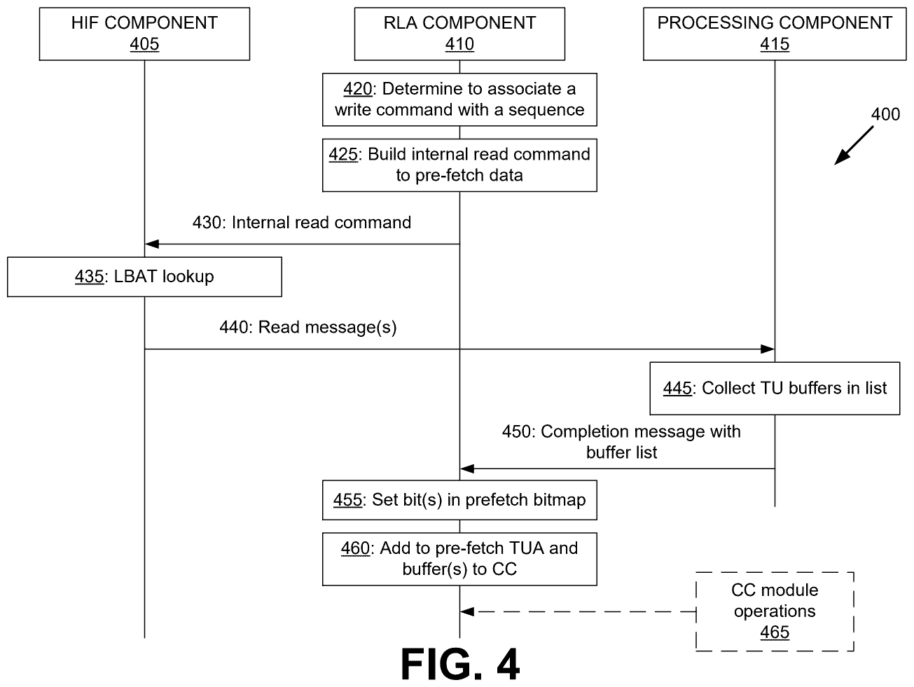

FIG. 4 is a sequence diagram illustrating an example method of using a read look-ahead for merging write command data with sequential write stream data, in accordance with some aspects of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated aspects should be understood only as examples, and the illustrated processes can be performed in a different order, and some processes can be performed in parallel. Additionally, one or more processes can be omitted in various aspects. Thus, not all processes are required in every aspect. Other process flows are possible.

A host interface (HIF) component 405, an RLA component 410, and a processing component 415 may communicate. The HIF component 405 may enable the memory sub-system 110 to pass control signals, address signals, data signals, and other signals to the host system 120. At least one of the HIF component 405, RLA component 410, or processing component 415 may be included in the memory sub-system controller 115. For example, the RLA component 410 may be, may include, or may be included in the sequential write component 113. Additionally, or alternatively, the processing component 415 may be, may include, or may be included in the processor 117. Other arrangements are possible.

At operation 420, the RLA component 410 determines to associate a write command with a sequence. For example, the RLA component 410 may determine that the write command is to be associated with a sequential write stream. In some aspects, the RLA component 410 can determine to associate the write command with a sequence based on monitoring information (such as access patterns and addresses) of one or more previous write commands. If the RLA component 410 observes that data is to be written in a consecutive order, with increasing memory addresses or block numbers, the RLA component 410 can determine that the write command is part of the sequence. In some aspects, if a host command is a write command, memory device firmware may use the RLA component 410 to check if the command is to be treated as a sequence. When a new stream is detected or when an existing stream is approaching the end of its pre-fetched data, the firmware may send a pre-fetch request to the RLA component 410. In some aspects, the RLA component 410 may determine to associate the write command with the sequence based on a write command logical block address, an NLB, and a queue depth. The RLA component 410 may issue periodic pre-fetch requests based on the stream progression and pre-fetch data availability.

At operation 425, the RLA component 410 builds an internal read command to pre-fetch data. For example, the RLA component 410 may generate a read command that indicates to read other data from one or more subsequent logical block addresses in the sequential write stream. In some aspects, the RLA component 410 may use an RLA to determine the one or more subsequent logical block addresses in the sequential write stream. The RLA may enable the RLA component 410 to proactively fetch the other data from the memory device based on the assumption that the memory sub-system will likely access this additional data in the near future due to the sequential access pattern. In some aspects, the RLA component 410 may build the internal read command (e.g., an internal read pre-fetch command) based on the stream pre-fetch request logical block address, the NLB, and/or the string identifier (ID).

At operation 430, the RLA component 410 sends an internal read command to the HIF component 405. For example, the RLA component 410 may send, and the HIF component 405 may receive, an internal read command that indicates to read the other data from the memory device.

At operation 435, the HIF component 405 performs an LBAT lookup. For example, the HIF component 405 may perform a lookup (e.g., using a lookup table) to identify one or more logical block addresses (and/or one or more physical block addresses) where the other data is located.

At operation 440, the HIF component 405 sends one or more read messages to the processing component 415. For example, the HIF component 405 may send, and the processing component 415 may receive, one or more read messages indicating to read the other data from the memory device. The one or more read messages may include the one or more logical block addresses (and/or the one or more physical addresses) where the other data is located.

At operation 445, the processing component 415 collects one or more translation unit buffers in a list. The processing component 415 may receive a plurality of translation unit completion indications and may aggregate the plurality of translation unit completion indications in a buffer list. The buffer list may include a plurality of translation unit buffers, where each translation unit buffer corresponds to one or more of the translation unit completion messages.

In some aspects, a buffer list and bitmap may be used to perform prefetch data buffer management. Data that is read in advance by the RLA component 410 may be stored in the data buffer(s), and the data buffer information and translation unit address (TUA) may be stored in a buffer list. In one example, a single buffer list may store thirty-two 4 KB data buffer indexes after an internal read of thirty-two 4 KBs of data is performed. Buffer list information may be sent to the RLA component 410 in a single message, and a bitmap may be used to represent which buffer index is used by the RLA component 410. For example, one thousand bits may be used to represent one thousand corresponding data buffers, where a first value (e.g., 1) of a bit indicates that the corresponding buffer is used and a second value (e.g., 0) of a bit indicates that the corresponding buffer is free.

At operation 450, the processing component 415 sends a completion message with the buffer list to the RLA component 410. For example, the processing component 415 may send, and the RLA component 410 may receive, a single completion message that includes the buffer list indicating the plurality of translation unit buffers.

At operation 455, the RLA component 410 sets one or more bits in a pre-fetch bitmap. For example, the RLA component 410 may set a bit in a pre-fetch bitmap for each translation unit completion indication received from the processing component 415. Therefore, the pre-fetch bitmap may indicate one or more pre-fetch buffers that are active (e.g., in use), where each pre-fetch buffer corresponds to one or more translation unit completion indications received from the processing component 415.

At operation 460, the RLA component 410 indicates to pre-fetch one or more translation unit addresses (TUA) and corresponding buffers. For example, the RLA component 410, using one or more command completion indications, may indicate to pre-fetch the translation unit addresses associated with the command completion indications and the corresponding buffers.

At operation 465, a TUA and buffer index may be stored in a coherency check (CC) module. The CC module may be used to check whether a new TUA command (cmd) is the same as a previous TUA command. In one example, LBA 0-3 may be associated with a first TUA (TUA 0) while LBA 407 may be associated with a second TUA (TUA 1). Thus, if an RLA read for LBA 4-7 is performed, the RLC component 410 may add TUA 1 and the corresponding buffer index to the CC. When the host writes to LBA 1, the firmware may send a CC add command to the CC module with an indication to write to TUA 1 and the buffer index. The CC may return information that TUA 1 data has been stored in a write stream by the RLC component 410. Thereafter, write data can merge with the write stream.

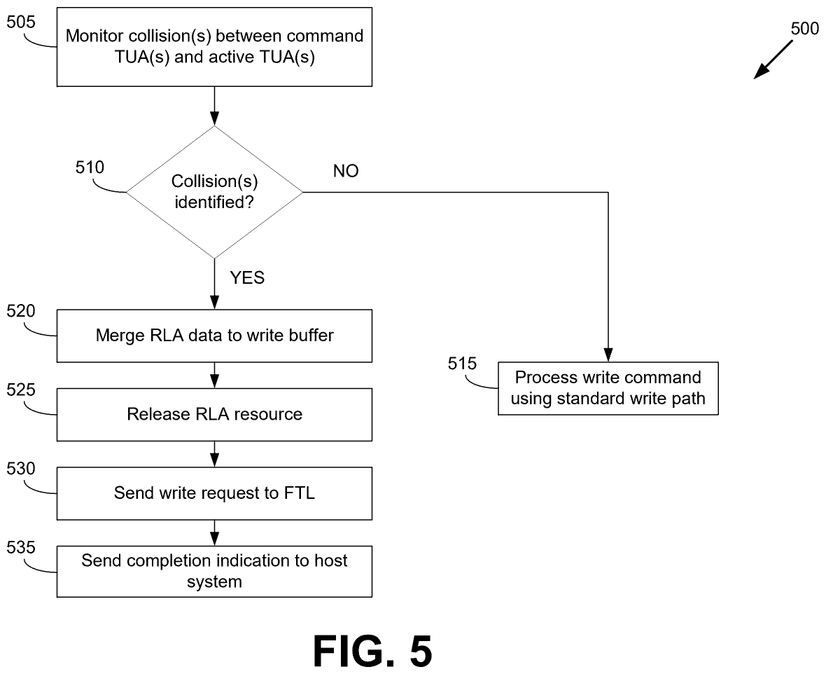

FIG. 5 is a flow diagram of an example method of merging write command data with sequential write stream data based on translation unit addresses, in accordance with some aspects of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some aspects, the method 500 is performed by the sequential write component 113 of FIG. 1. Although shown in a particular sequence or order, unless otherwise specified, the order of the processes can be modified. Thus, the illustrated aspects should be understood only as examples, and the illustrated processes can be performed in a different order, and some processes can be performed in parallel. Additionally, one or more processes can be omitted in various aspects. Thus, not all processes are required in every aspect. Other process flows are possible.

At operation 505, the processing logic monitors for collisions between one or more command translation unit addresses and one or more active translation unit addresses. A collision between the one or more command translation unit addresses and the one or more active translation unit addresses may correspond to an overlap between the one or more command translation unit addresses and the one or more active translation unit addresses. For example, RLA logic (such as the RLA component 410) associated with the sequential write component 113 may process an incoming write command (such as the write command that indicates to write data to the memory device) and may issue a command (such as a command completion add request) to determine whether one or more command translation unit addresses (associated with the write command) correspond to any active translation unit addresses. An active translation unit address may refer to a logical unit that is currently being used for mapping logical block addresses to physical addresses on the memory device.

At operation 510, the processing logic identifies whether any collisions have been identified. For example, the processing logic may identify whether any command translation unit addresses correspond to any of the active translation unit addresses. In some aspects, operation 510 may be similar or identical to operation 460 described in connection with FIG. 4.

At operation 515, the processing logic processes the write command using a standard write path based on no collisions being identified. For example, the processing logic may determine that no collisions exist between the command translation unit addresses and the active translation unit addresses and may process the write command using a standard write path (for example, without using an RLA).

At operation 520, the processing logic may merge the RLA data to a write buffer based on identifying at least one collision. For example, the processing logic may determine that at least one collision exists between the command translation unit addresses and the active translation unit addresses and may merge the RLA data with data in the write buffer (e.g., data included in the write command).

At operation 525, the processing logic releases the RLA resource. For example, the processing logic may make an RLA resource (used for accessing data associated with the sequential write stream) available for subsequent RLA operations.

At operation 530, the processing logic sends a write request to the FTL. For example, the processing logic may send, and the FTL may receive, a request to write the merged data that includes the RLA data and the data included in the write command. As described herein, the size of the merged data may be equal to the translation unit size. For example, the merged data may include 4 kilobytes of host data and 12 kilobytes of RLA data.

At operation 535, the processing logic sends a completion message to the host system. For example, the processing logic may send, via the host interface, and the host system may receive, a completion message indicating that the merged data has been written to the memory device.

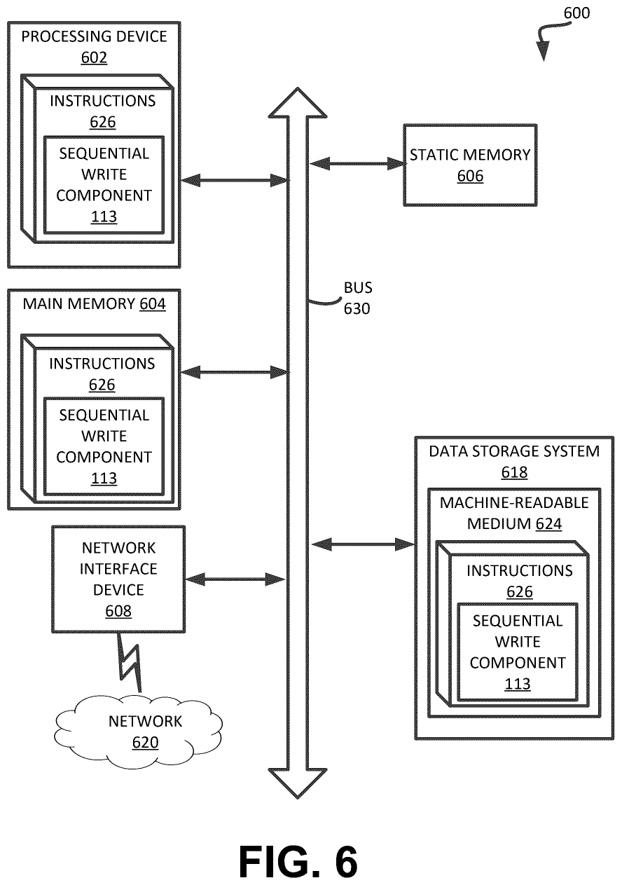

FIG. 6 illustrates an example machine of a computer system 600 within which a set of instructions, for causing the machine to perform any one or more of the methodologies discussed herein, can be executed. In some aspects, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the sequential write component 113 of FIG. 1). In alternative aspects, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In some aspects, the instructions 626 include instructions to implement functionality corresponding to the sequential write component 113 of FIG. 1). While the machine-readable storage medium 624 is shown in an example aspect to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some aspects, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, aspects of the disclosure have been described with reference to specific example aspects thereof. It will be evident that various modifications can be made thereto without departing from the broader spirit and scope of aspects of the disclosure as set forth in the following claims. The specification and drawings are, accordingly, to be regarded in an illustrative sense rather than a restrictive sense.

What is claimed is:

1. A system comprising:
a memory device; and
a memory sub-system controller, coupled with the memory device, configured to perform operations comprising:
receiving a write command that indicates to write data to the memory device, wherein a size of the data is smaller than a translation unit size;
determining that the write command is associated with a sequential write stream;
generating, based on the write command being associated with the sequential write stream, a read command that indicates to read other data associated with the sequential write stream from the memory device;
executing a read operation associated with the read command to read the other data from the memory device;
merging the data and the other data to form merged data, wherein a size of the merged data is equal to the translation unit size; and
executing a program operation to write the merged data to the memory device.

2. The system of claim 1, wherein the memory sub-system controller is further configured to perform operations comprising identifying the other data associated with the sequential write stream using a read look-ahead operation.

3. The system of claim 1, wherein determining that the write command is associated with the sequential write stream comprises determining that the write command is associated with the sequential write stream based on a logical block address of the write command, a number of logical block addresses in the write command, and a queue depth.

4. The system of claim 1, wherein the memory sub-system controller is further configured to perform operations comprising:
adding the read command to a queue, wherein the read command is an internal read command that indicates to pre-fetch the other data associated with the sequential write stream;
receiving a translation unit completion message that includes a buffer list, wherein the buffer list includes a plurality of translation unit buffers;
setting one or more bits in a pre-fetch bitmap, wherein each bit of the one or more bits corresponds to a translation unit buffer of the plurality of translation unit buffers; and
sending, based on setting the one or more bits in the pre-fetch bitmap, a request to pre-fetch the other data from a plurality of translation unit addresses associated with the plurality of translation unit buffers.

5. The system of claim 1, wherein the memory sub-system controller is further configured to perform operations comprising:
identifying, based on performing a logical block address table lookup, one or more logical block addresses for the other data associated with the sequential write stream; and
sending, to a central processing unit of the memory device, a read message that includes the one or more logical block addresses.

6. The system of claim 1, wherein the memory sub-system controller is further configured to perform operations comprising:
aggregating a plurality of translation unit completion indications, wherein each translation unit completion indication of the plurality of translation unit completion indications indicates a completion of a data transfer operation for a corresponding translation unit;
generating, based on the plurality of translation unit completion indications, a buffer list that includes a plurality of translation unit buffers; and
sending a completion message that includes the plurality of translation unit buffers.

7. The system of claim 1, wherein the memory sub-system controller is further configured to perform operations comprising:
determining that a translation unit address associated with the other data overlaps with one or more active translation unit addresses, wherein merging the data and the other data comprises merging the data and the other data in a write buffer based on the translation unit address associated with the other data overlapping with the one or more active translation unit addresses;
sending, to a flash translation layer, a request to write the merged data to the memory device; and
sending, to a host device, an indication of a completion of the write command.

8. A method comprising:
receiving a write command that indicates to write data to a memory device, wherein a size of the data is smaller than a translation unit size;
determining that the write command is associated with a sequential write stream;
generating, based on the write command being associated with the sequential write stream, a read command that indicates to read other data associated with the sequential write stream from the memory device;
executing a read operation associated with the read command to read the other data from the memory device;
merging the data and the other data to form merged data, wherein a size of the merged data is equal to the translation unit size; and
executing a program operation to write the merged data to the memory device.

9. The method of claim 8, further comprising identifying the other data associated with the sequential write stream using a read look-ahead operation.

10. The method of claim 8, wherein determining that the write command is associated with the sequential write stream comprises determining that the write command is associated with the sequential write stream based on a logical block address of the write command, a number of logical block addresses in the write command, and a queue depth.

11. The method of claim 8, further comprising:
adding the read command to a queue, wherein the read command is an internal read command that indicates to pre-fetch the other data associated with the sequential write stream;
receiving a translation unit completion message that includes a buffer list, wherein the buffer list includes a plurality of translation unit buffers;
setting one or more bits in a pre-fetch bitmap, wherein each bit of the one or more bits corresponds to a translation unit buffer of the plurality of translation unit buffers; and
sending, based on setting the one or more bits in the pre-fetch bitmap, a request to pre-fetch the other data from a plurality of translation unit addresses associated with the plurality of translation unit buffers.

12. The method of claim 8, further comprising:
identifying, based on performing a logical block address table lookup, one or more logical block addresses for the other data associated with the sequential write stream; and
sending, to a central processing unit of the memory device, a read message that includes the one or more logical block addresses.

13. The method of claim 8, further comprising:
aggregating a plurality of translation unit completion indications, wherein each translation unit completion indication of the plurality of translation unit completion indications indicates a completion of a data transfer operation for a corresponding translation unit;
generating, based on the plurality of translation unit completion indications, a buffer list that includes a plurality of translation unit buffers; and
sending a completion message that includes the plurality of translation unit buffers.

14. The method of claim 8, further comprising:
determining that a translation unit address associated with the other data overlaps with one or more active translation unit addresses, wherein merging the data and the other data comprises merging the data and the other data in a write buffer based on the translation unit address associated with the other data overlapping with the one or more active translation unit addresses;
sending, to a flash translation layer, a request to write the merged data to the memory device; and
sending, to a host device, an indication of a completion of the write command.

15. A non-transitory computer-readable storage medium comprising instructions that, when executed by a processing device, cause the processing device to perform operations comprising:
receiving a write command that indicates to write data to a memory device, wherein a size of the data is smaller than a translation unit size;
determining that the write command is associated with a sequential write stream;
generating, based on the write command being associated with the sequential write stream, a read command that indicates to read other data associated with the sequential write stream from the memory device;
executing a read operation associated with the read command to read the other data from the memory device;
merging the data and the other data to form merged data, wherein a size of the merged data is equal to the translation unit size; and
executing a program operation to write the merged data to the memory device.

16. The non-transitory computer-readable storage medium of claim 15, wherein the instructions, when executed by the processing device, further cause the processing device to perform operations comprising identifying the other data associated with the sequential write stream using a read look-ahead operation.

17. The non-transitory computer-readable storage medium of claim 15, wherein determining that the write command is associated with the sequential write stream comprises determining that the write command is associated with the sequential write stream based on a logical block address of the write command, a number of logical block addresses in the write command, and a queue depth.

18. The non-transitory computer-readable storage medium of claim 15, wherein the instructions, when executed by the processing device, further cause the processing device to perform operations comprising:
adding the read command to a queue, wherein the read command is an internal read command that indicates to pre-fetch the other data associated with the sequential write stream;
receiving a translation unit completion message that includes a buffer list, wherein the buffer list includes a plurality of translation unit buffers;
setting one or more bits in a pre-fetch bitmap, wherein each bit of the one or more bits corresponds to a translation unit buffer of the plurality of translation unit buffers; and
sending, based on setting the one or more bits in the pre-fetch bitmap, a request to pre-fetch the other data from a plurality of translation unit addresses associated with the plurality of translation unit buffers.

19. The non-transitory computer-readable storage medium of claim 15, wherein the instructions, when executed by the processing device, further cause the processing device to perform operations comprising:
identifying, based on performing a logical block address table lookup, one or more logical block addresses for the other data associated with the sequential write stream; and
sending, to a central processing unit of the memory device, a read message that includes the one or more logical block addresses.

20. The non-transitory computer-readable storage medium of claim 15, wherein the instructions, when executed by the processing device, further cause the processing device to perform operations comprising:
determining that a translation unit address associated with the other data overlaps with one or more active translation unit addresses, wherein merging the data and the other data comprises merging the data and the other data in a write buffer based on the translation unit address associated with the other data overlapping with the one or more active translation unit addresses;
sending, to a flash translation layer, a request to write the merged data to the memory device; and
sending, to a host device, an indication of a completion of the write command.
